(19) United States
(12) Patent Application Publication
(10) Pub. No.: US 2022/0126575 A1
(43) Pub. Date: Apr. 28, 2022

(54) LIQUID DISCHARGE HEAD, LIQUID DISCHARGE DEVICE, AND LIQUID DISCHARGE APPARATUS

(71) Applicants: Yukio OTOME, Ibaraki (JP); Takayuki NAKAI, Kanagawa (JP)

(72) Inventors: Yukio OTOME, Ibaraki (JP); Takayuki NAKAI, Kanagawa (JP)

(73) Assignee: Ricoh Company, Ltd.

(21) Appl. No.: 17/509,101

(22) Filed: Oct. 25, 2021

(30) Foreign Application Priority Data
Oct. 27, 2020 (JP) 2020-179716

(51) Int. Cl. B41J 2/14; B41J 2/175

(52) U.S. Cl. CPC B41J 2/14048; B41J 2/17596; B41J 2/14274

(57) ABSTRACT

A liquid discharge head includes a nozzle to discharge a liquid, a pressure generation chamber facing the nozzle, a common liquid chamber to supply the liquid to the pressure generation chamber, a fluid restrictor communicating with the pressure generation chamber, and a guide channel communicating with the fluid restrictor and the common liquid chamber. The guide channel includes a first adjacent portion communicating with the fluid restrictor. The pressure generation chamber has a first resonance period, and the guide channel has a second resonance period different from the first resonance period.

### CROSS-REFERENCE TO RELATED APPLICATION

This patent application is based on and claims priority pursuant to 35 U.S.C. § 119(a) to Japanese Patent Application No. 2020-179716, filed on Oct. 27, 2020, in the Japan Patent Office, the entire disclosure of which is hereby incorporated by reference herein.

### BACKGROUND

### Technical Field

Aspects of the present disclosure relate to a liquid discharge head, a liquid discharge device, and a liquid discharge apparatus.

### Description of the Related Art

In a liquid discharge head, a voltage is applied to a piezoelectric element to vibrate a diaphragm, thereby generating a pressure wave in liquid in a pressure generation chamber. Thus, the liquid discharge head can discharge the liquid in the pressure generation chamber from a nozzle.

### SUMMARY

Embodiments of the present disclosure describe an improved liquid discharge head that includes a nozzle to discharge a liquid, a pressure generation chamber facing the nozzle, a common liquid chamber to supply the liquid to the pressure generation chamber, a fluid restrictor communicating with the pressure generation chamber, and a guide channel communicating with the fluid restrictor and the common liquid chamber. The guide channel includes a first adjacent portion communicating with the fluid restrictor. The pressure generation chamber has a first resonance period, and the guide channel has a second resonance period different from the first resonance period.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross-sectional view of a liquid discharge head according to a first embodiment of the present disclosure, in a direction perpendicular to a nozzle array direction;

FIG. 2 is a cross-sectional view of a portion of the liquid discharge head in FIG. 1 in the nozzle array direction;

FIG. 3 is a plan view of a portion of the liquid discharge head in FIG. 1;

FIG. 4 is a graph illustrating a relation between a ratio of resonance periods in the liquid discharge head and a variation in the speed of ink;

FIG. 5 is a perspective view of a liquid discharge head according to a second embodiment of the present disclosure;

FIG. 6 is a cross-sectional view of the liquid discharge head in FIG. 5 in a direction perpendicular to a nozzle array direction;

FIG. 7 is a schematic view of a liquid discharge apparatus according to embodiments of the present disclosure;

FIG. 8 is a plan view illustrating an example of a head unit of the liquid discharge apparatus in FIG. 7;

FIG. 9 is a block diagram of a liquid circulation device according to embodiments of the present disclosure;

FIG. 10 is a plan view of a part of a printing apparatus according to another embodiment of the present disclosure;

FIG. 11 is a side view of a part of the printing apparatus in FIG. 10;

FIG. 12 is a plan view of a part of a liquid discharge device according to still another embodiment of the present disclosure; and

FIG. 13 is a front view of a part of a liquid discharge device according to yet another embodiment of the present disclosure.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a,” “an,” and “the” are intended to include the plural forms as well, unless the context clearly indicates otherwise.

In a liquid discharge head, a pressure wave generated in a pressure generation chamber propagates to another pressure generation chamber via a fluid restrictor, a guide channel, and the common liquid chamber. Therefore, when the number of a piezoelectric elements is large, pressure waves propagated from other pressure generation chambers overlap. Thus, the amplitudes of the pressure waves in the respective pressure generation chambers increase or decrease.

Due to the fluctuation of the amplitude of the pressure wave, the speed and volume of liquid discharged from each pressure generation chamber are different. Accordingly, a landing position and a print density of the liquid may vary. In particular, when an image forming apparatus includes the liquid discharge head, the variations in the landing position and the print density may cause the deterioration in the print quality.

According to the present disclosure, the liquid discharge head can suppress variations in the speed and volume of the liquid discharged from the nozzle.

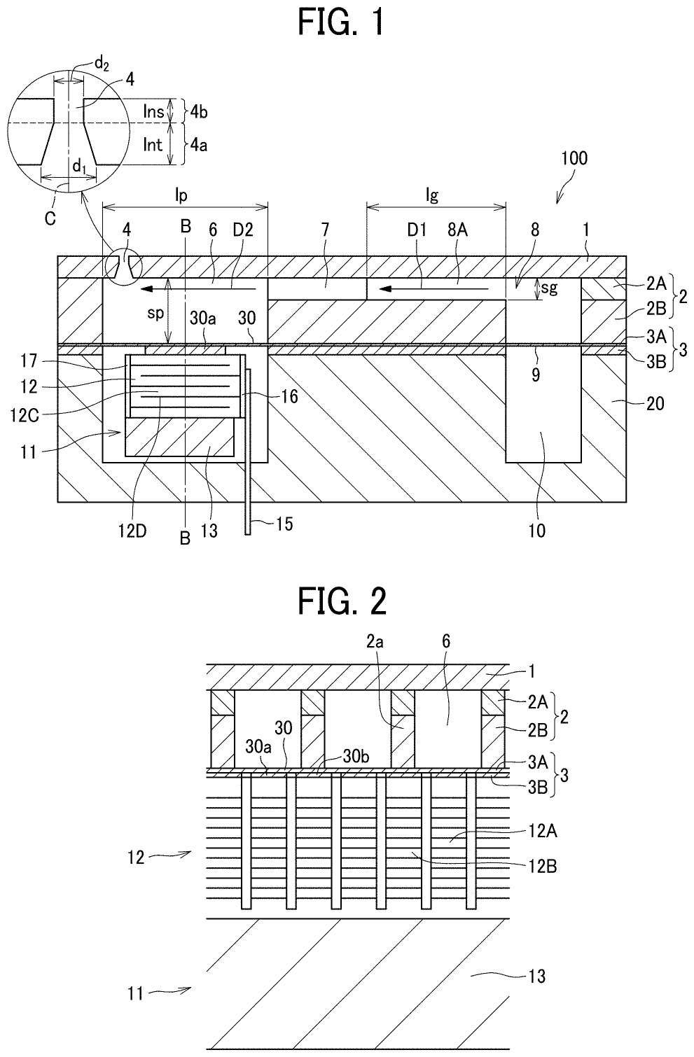

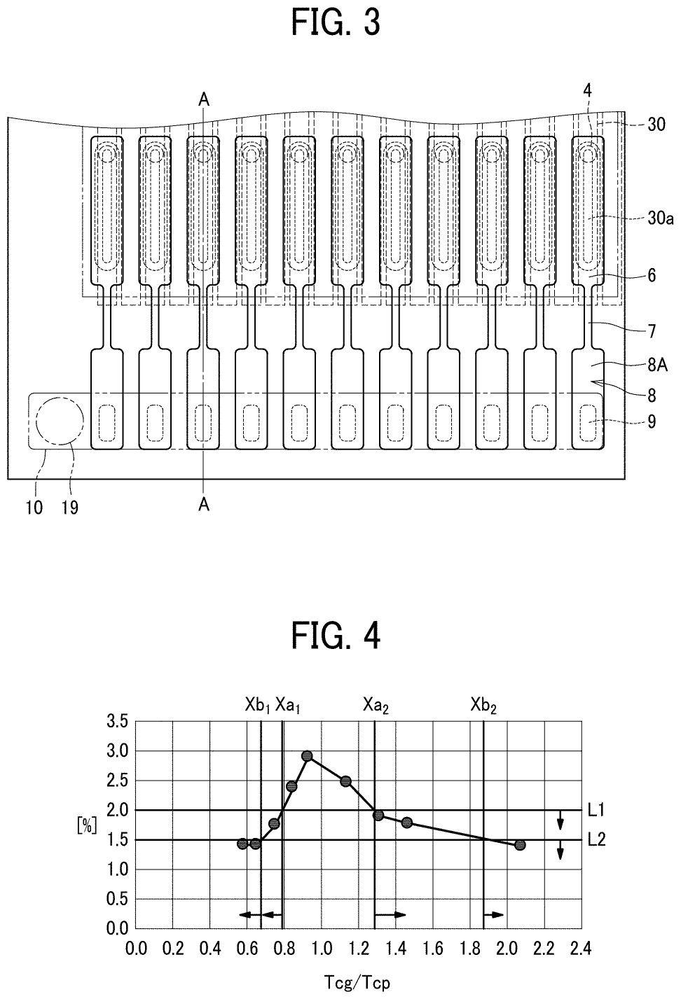

Embodiments of the present disclosure are described below with reference to the attached drawings. A liquid discharge head 100 according to a first embodiment of the present disclosure is described with reference to FIGS. 1 to 3. Hereinafter, the “liquid discharge head” is simply referred to as the “head.” FIG. 1 is a cross-sectional view of the head 100 along line A-A in FIG. 3, that is, a cross-sectional view in a direction (longitudinal direction of a pressure generation chamber 6) perpendicular to a nozzle array direction. FIG. 2 is a cross-sectional view of the head 100 along line B-B in FIG. 1, that is, a cross-sectional view in the nozzle array direction (transverse direction of the pressure generation chamber 6). FIG. 3 is a plan view of the head 100 with a plate member 2A as the top surface.

The head 100 includes a nozzle plate 1, a channel plate 2, and a diaphragm 3 that are laminated one on another and bonded to each other. The diaphragm 3 includes thin-film layers serving as a wall. The head 100 further includes a piezoelectric actuator 11 and a frame 20 as a common liquid chamber substrate. The piezoelectric actuator 11 displaces the diaphragm 3.

The nozzle plate 1 is formed of a metal material, for example, steel use stainless (SUS). The nozzle plate 1 includes a plurality of nozzles 4 to discharge liquid. The plurality of nozzles 4 are arranged in a direction perpendicular to the surface of the paper on which FIG. 1 is drawn (i.e., the nozzle array direction). In the present embodiment, for example, 320 nozzles 4 are provided at intervals of 150 dots per inch (dpi). Each nozzle 4 is formed by, for example, etching or pressing.

The nozzle 4 according to the present embodiment includes a tapered portion 4a and a straight portion 4b. The tapered portion 4a communicates with the pressure generation chamber 6, and the straight portion 4b communicates with the outside of the nozzle plate 1. The tapered portion 4a has a tapered surface. A diameter of the tapered portion 4a decreases upward in FIG. 1 along the tapered surface. A diameter of the straight portion 4b is constant.

The channel plate 2 includes a plurality of (in the present embodiment, two) plate members 2A and 2B laminated one on another in a thickness direction of the channel plate 2. The plate members 2A and 2B are made of a metallic material, for example, SUS. The channel plate 2 defines the pressure generation chamber 6, a fluid restrictor 7, and a guide channel 8. That is, through holes serving as the pressure generation chamber 6, the fluid restrictor 7, and the guide channel 8 are formed in the plate members 2A and 2B by etching or pressing. Note that the through hole as the fluid restrictor 7 is formed only in the plate member 2A.

The pressure generation chamber 6 communicates with the corresponding one of the plurality of nozzles 4 and communicates with other nozzles 4 and other pressure generation chambers 6 via a common liquid chamber 10. Portions of the plate members 2A and 2B that have not been removed in the thickness direction by hole processing are stacked to form the partitions 2a illustrated in FIG. 2. The frame 20 is made of, for example, SUS. The common liquid chamber 10 and a supply hole 19 (see FIG. 3) communicating with the common liquid chamber 10 are formed in the frame 20 made of SUS by cutting.

The diaphragm 3 serves as a wall of the pressure generation chamber 6 of the channel plate 2. The diaphragm 3 has a two layer structure including a first layer 3A and a second layer 3B. Note that the number of layers of the diaphragm 3 is not limited to two and may be one, or three or more. A portion of the first layer 3A corresponding to the pressure generation chamber 6 on the channel plate 2 side serves as a deformable vibration region (vibration plate) 30. In addition, an opening 9 that connects the common liquid chamber 10 and the guide channel 8 is formed in the first layer 3A. The diaphragm 3 is formed of a metal plate of nickel (Ni) by electroforming. The material of the diaphragm 3 is not limited to Ni. In some embodiments, other metal member or a member including a plurality of layers of resin and metal may be used to form the diaphragm 3.

Ink (liquid) is introduced from the common liquid chamber 10 to the guide channel 8 through the opening 9. Then, the ink is supplied from the guide channel 8 to the pressure generation chamber 6 via the fluid restrictor 7. Note that a filter may be disposed at the opening 9. As illustrated in FIG. 3, the fluid restrictor 7 is narrower than other ink channels (liquid channels) such as the guide channel 8 and the pressure generation chamber 6. The fluid restrictor 7 communicates with the pressure generation chamber 6. The guide channel 8 communicates with the fluid restrictor 7 and the common liquid chamber 10 to form the ink channel (liquid channel) from the common liquid chamber 10 to the fluid restrictor 7. That is, the common liquid chamber 10 communicates with the pressure generation chamber 6 via the fluid restrictor 7 to supply liquid to the pressure generation chamber 6.

The piezoelectric actuator 11 is disposed opposite to the pressure generation chamber 6 via the diaphragm 3. The piezoelectric actuator 11 includes an electromechanical transducer element serving as a driving device (an actuator device or a pressure generator device) to deform a vibration region 30 of the diaphragm 3. The piezoelectric actuator 11 includes a piezoelectric member 12 bonded on a base 13. The piezoelectric member 12 has a comb shape in which a predetermined number of columnar piezoelectric elements 12A and 12B are arranged at a predetermined interval in the nozzle array direction. A piezoelectric material bonded to the base 13 is grooved by half-cut dicing, thereby forming the combshaped piezoelectric member 12.

The piezoelectric elements 12A and 12B are made of the same material. As a drive waveform is applied, the piezoelectric element (drive portion) 12A is driven. On the other hand, the drive waveform is not applied to the piezoelectric element (non-drive portion) 12B, and the piezoelectric element 12B merely serves as a support pillar. The piezoelectric element 12A is bonded to a projection 30a. The projection 30a is an island-shaped thick portion formed in the vibration region 30. The piezoelectric element 12B is bonded to a projection 30b, which is a thick portion of the diaphragm 3.

The piezoelectric member 12 includes piezoelectric layers 12C and internal electrodes 12D alternately laminated on each other. The piezoelectric layers 12C are made of lead zirconate titanate (PZT), and each piezoelectric layer 12C has a thickness of 10 to 50 μm. The internal electrodes 12D are made of silver-palladium (AgPd), and each internal electrode 12D has a thickness of several μm. The internal electrodes 12D are led out to both end faces of the piezoelectric member 12 in the longitudinal direction of the pressure generation chamber 6, and are connected to the individual electrodes 16 and the common electrode 17, which are end face electrodes (external electrodes), respectively.

The external electrode on one side of the piezoelectric member 12 is divided into multiple individual electrodes 16 by half-cut dicing. The length of the electrode on the end face of the piezoelectric member 12 is regulated in advance by processing of being cut off, for example. The common electrode 17 is not divided by dicing, and is conductive in such a shape. A flexible printed circuit (FPC) 15 as a flexible wiring is connected to the individual electrodes 16 by soldering. The common electrode 17 is connected to a ground electrode on the FPC 15 via an electrode layer provided on the piezoelectric member 12. The electrode layer is disposed around the end face of the piezoelectric member 12. A driver integrated circuit (IC) is mounted on the FPC 15. The driver IC controls a voltage applied to the piezoelectric elements 12A.

In the head 100 thus configured, as the drive waveform (e.g., a pulse voltage of 10 to 50 V) is applied to the piezoelectric element 12A based on recording signals, the piezoelectric element 12A is displaced in the direction of lamination. This displacement of the piezoelectric element 12A pressurizes the pressure generation chamber 6 via the diaphragm 3. As a result, an ink pressure in the pressure generation chamber 6 increases, and ink droplets are discharged from the nozzle 4 (i.e., ink discharge).

When the head 100 stops discharging the ink droplets, the ink pressure in the pressure generation chamber 6 decreases. Then, a negative pressure is generated in the pressure generation chamber 6 due to the inertia of the ink flow and the displacement of the piezoelectric element 12A in the discharge process of the drive pulse, thereby proceeding to the ink filling step. At this time, ink supplied from an external ink tank flows into the common liquid chamber 10, passes through the guide channel 8 and the fluid restrictor 7 from the common liquid chamber 10 via the opening 9, and enters the pressure generation chamber 6. As a result, the pressure generation chamber 6 is filled with the ink.

The fluid restrictor 7 can attenuate residual pressure vibration after the ink discharge. However, when the pressure generation chamber 6 is refilled with the ink by surface tension, the fluid restrictor 7 resists refilling the pressure generation chamber 6 with ink. Appropriate configuration of the fluid restrictor 7 balances the attenuation of the residual pressure vibration and the refill time, and the time (drive cycle) until the next ink discharge can be shortened.

In the head 100 described above, when the drive waveform is applied to the piezoelectric element 12A to generate a negative pressure in the pressure generation chamber 6, a pressure wave is generated in the pressure generation chamber 6. This pressure wave propagates to another pressure generation chamber 6 via the fluid restrictor 7, the guide channel 8, and the common liquid chamber 10. As a result, when the number of the piezoelectric elements 12A is large, pressure waves propagated from other pressure generation chambers 6 overlap, and the amplitudes of the pressure waves in the respective pressure generation chambers 6 increase or decrease. Due to the fluctuation of the amplitude of the pressure wave, the speed and volume of the ink discharged from each pressure generation chamber 6 are different. Accordingly, variations in the speed and volume of the ink may cause the variation in the landing position of the ink, the variation in the print density, and the deterioration in the print quality due to the variations in the landing position and the print density.

In particular, when a resonance period Tcp of the pressure generation chamber 6 is close to a resonance period Tcg of a first adjacent portion 8A of the guide channel 8, the pressure generation chamber 6 resonates with the guide channel 8 due to the pressure wave of the pressure generation chamber 6. As a result, the amplitude of the residual pressure vibration may increase or may be unlikely to attenuate. When the head 100 includes a large number of piezoelectric elements 12A to which voltages are applied, each pressure generation chamber 6 may receive a different influence of the propagated pressure wave, and the speed and volume of the discharged ink (liquid) may vary significantly.

The first adjacent portion 8A is a portion of the guide channel 8. That is, the first adjacent portion 8A communicates with (is adjacent to) the fluid restrictor 7, and has a substantially uniform shape in a certain range when viewed from the fluid restrictor 7. More specifically, the first adjacent portion 8A is disposed in the certain range in which the substantially uniform shape continues in cross-section. Here, the cross-section is along a first direction (in particular, a vertical direction in the present embodiment) and continuously taken along a second direction (a right direction in FIG. 1). The first direction intersects the second direction. The second direction is opposite to the direction in which a fluid mainly flows in the portion of the guide channel 8 adjacent to the fluid restrictor 7 (in the present embodiment, the second direction is opposite to the direction in which the fluid flows in the fluid restrictor 7). In the present embodiment, a portion having a length lg indicated by arrow in FIG. 1 is the first adjacent portion 8A. However, the uniform shape may not be strictly uniform, and may have some changes in shape such as unevenness. On the right side of the portion having the length lg in FIG. 1, the guide channel 8 extends downward as illustrated in the drawing. The right side portion of the guide channel 8 has a shape different from that of the portion of the guide channel 8 adjacent to the fluid restrictor 7 (the fluid such as ink also flows in a different direction). That is, the right side portion of the guide channel 8 does not have the uniform shape described above, and is not included in the first adjacent portion 8A.

In the present embodiment, the resonance period Tcg of the first adjacent portion 8A and the resonance period Tcp of the pressure generation chamber 6 are different. As a result, a variation in meniscus pressure can be suppressed between the pressure generation chambers 6 when pressure is applied to each pressure generation chamber 6. Therefore, the variations in the speed and volume of the ink discharged from the nozzles 4 can be suppressed in a nozzle array of the nozzles 4. Thus, variations in ink landing positions and print density can be suppressed in the nozzle array of the nozzles 4, thereby improving the print quality by liquid discharge of the head 100.

The resonance period Tcp of the pressure generation chamber 6 and the resonance period Tcg of the first adjacent portion 8A are defined as follows. Thus, the influence of the pressure wave can be further reduced. The resonance period Tcp of the pressure generation chamber 6 and the resonance period Tcg of the first adjacent portion 8A are calculated by the following expressions 2 to 10:

$$\begin{matrix}Tcp = 2 π \times [ √ \{ ( Lp + Ln ) \times Cp \} + √ ( Lp \times Cp ) ] \text{/} 2 ; & Expression 2 \\ Lp = ρ \times ( 1 p \text{/} 2 ) \text{/} sp ; & Expression 3 \\ Ln = Lnt + Lns ; & Expression 4 \\ Lnt = 4 \times ρ \times 1 nt \text{/} ( π \times {d}_{1} \times {d}_{2} ) ; & Expression 5 \\ Lns = 4 \times ρ \times 1 ns \text{/} ( π \times {d}_{2}^{2} ) ; & Expression 6 \\ Cp = ( 1 p \text{/} 2 ) \times sp \text{/} ( ρ \times {c}^{2} ) \times 2.5 ; & Expression 7 \\ Tcg = 2 π \times √ ( Lg \times Cg ) ; & Expression 8 \\ Lg = ρ \times ( 1 g \text{/} 2 ) \text{/} sg ; and & Expression 9 \\ Cg = ( 1 g \text{/} 2 ) \times sg \text{/} ( ρ \times {c}^{2} ) . & Expression 10\end{matrix}$$

Here:

Tcp (s) represents the resonance period of the pressure generation chamber 6;

Tcg (s) represents the resonance period of the first adjacent portion 8A;

ρ (kg/m³) represents a density of ink (liquid);

c (m/s) represents a sonic velocity in the ink (liquid);

lp (m) represents a length of the pressure generation chamber 6 in a direction in which the ink (liquid) flows in the pressure generation chamber 6;

sp (m²) represents a cross-sectional area of the pressure generation chamber 6 in a plane perpendicular to the direction in which the ink (liquid) flows in the pressure generation chamber 6;

lnt (m) represents a length of the tapered portion 4a along a center line of the nozzle 4;

lns (m) represents a length of the straight portion 4b along the center line of the nozzle 4;

d₁ (m) represents a first diameter of the nozzle 4;

d₂ (m) represents a second diameter of the nozzle 4;

lg (m) represents a length of the first adjacent portion 8A in a direction in which the ink (liquid) flows in the first adjacent portion 8A; and

sg (m²) represents a cross-sectional area of the first adjacent portion 8A in a plane perpendicular to the direction in which the ink (liquid) flows in the first adjacent portion 8A.

The lengths lp, lnt, lns, and lg and the diameters d₁, d₂ refer to the respective ranges indicated by arrows in FIG. 1. The cross-sectional area sp is defined by the range (i.e., the portion having the length lp) indicated by arrow in FIG. 1 and the width of the pressure generation chamber 6 in the direction perpendicular to the surface of the paper on which FIG. 1 is drawn, and the cross-sectional area sg is defined by the range (i.e., the portion having the length lg) indicated by arrow in FIG. 1 and the width of the first adjacent portion 8A in the direction perpendicular to the surface of the paper on which FIG. 1 is drawn. However, when the pressure generation chamber 6 is not a rectangular parallelepiped and the dimension thereof is not constant due to partial unevenness or the like, an average value of the length of the pressure generation chamber 6 in the horizontal direction in FIG. 1 may be calculated over the vertical direction in FIG. 1 along the short side of the pressure generation chamber 6 and can be used as the length lp. Similarly, when the pressure generation chamber 6 or the first adjacent portion 8A is not rectangular parallelepiped, the respective average values can be used as the length lg, and the cross-sectional areas sp and sg.

The nozzle 4 is centered on the center line indicated by alternate long and short dash line C in FIG. 1. Further, the first diameter d₁ of the nozzle 4 is the diameter of the inner circumferential surface of the tapered portion 4a at an end face of the nozzle plate 1 opposite the straight portion 4b. The second diameter d₂ of the nozzle 4 is the diameter of the inner circumferential surface of the straight portion 4b (in other words, the diameter of the tapered portion 4a at the connection to the straight portion 4b). However, when the nozzle 4 does not have the straight portion 4b but has only the tapered portion 4a, the first diameter d₁ of the nozzle 4 is the diameter of the tapered portion 4a at one end face of the nozzle plate 1 along the center line, the second diameter d₂ of the nozzle 4 is the diameter of the tapered portion 4a at the other end face of the nozzle plate 1 along the center line, and the length lns is equal to 0. When the nozzle 4 has only the straight portion 4b and does not have the tapered portion 4a, the first nozzle diameters d₁ is equal to 0, the length lnt is equal to 0, and the second nozzle diameter d₂ is the diameter of the straight portion 4b.

Liquid flows in the first adjacent portion 8A in the direction indicated by arrow D1 in FIG. 1, and flows in the pressure generation chamber 6 in the direction indicated by arrow D2 in FIG. 1. Although ink (liquid) flows in three directions (the vertical direction, the horizontal direction, and the direction perpendicular to the surface of the paper on which FIG. 1 is drawn) perpendicular to each other along wall surfaces defining the pressure generation chamber 6 or the guide channel 8, the ink (liquid) mainly flows in the first adjacent portion 8A and the pressure generation chamber 6 in the directions indicated by arrows D1 and D2 (a direction in which a distance of liquid flow is largest).

In the present embodiment, the density p of the ink is in a range of 900 to 1200 kg/m³, the sonic velocity c in the ink is in a range of 1000 to 1500 m/s, the pressure generation chamber 6 has the length lp in a range of 500×10⁻⁶ to 3000×10⁻⁶ m and the cross-sectional area sp in a range of 3200×10⁻¹² to 15600×10⁻¹² m², the tapered portion has the length lnt along the center line of the nozzle 4 in a range of 10×10⁻⁶ to 50×10⁻⁶ m, the straight portion 4b has the length lns along the center line of the nozzle 4 in a range of 3×10⁻⁶ to 30×10⁻⁶ m, the nozzle 4 has the first diameter d₁ in a range of 15×10⁻⁶ to 60×10⁻⁶ m and the second diameter d₂ in a range of 10×10⁻⁶ to 40×10⁻⁶ m, and the first adjacent portion 8A has the length lg in a range of 500×10⁻⁶ to 5000×10⁻⁶ m and the cross-sectional area sg in a range of 3200×10⁻¹² to 15600×10⁻¹² m².

The value of Tcg/Tcp is set in a range indicated by Expression 1 or Expression 11:

$$\begin{matrix}Tcg \text{/} Tcp \leq 0.79 or Tcg \text{/} Tcp \geq 1.29 ; or & Expression 1 \\ Tcg \text{/} Tcp \leq 0.68 or Tcg \text{/} Tcp \geq 1.88 . & Expression 11\end{matrix}$$

Here, Tcp (s) represents the resonance period of the pressure generation chamber 6, and Tcg (s) represents the resonance period of the first adjacent portion 8A.

Preferably, the resonance period Tcg of the first adjacent portion 8A and the resonance period Tcp of the pressure generation chamber 6 are set so as to satisfy Expression 1, thereby suppressing the variation in the meniscus pressure between the pressure generation chambers 6 when pressure is applied to each pressure generation chamber 6. With this setting, the variations in the speed and volume of the ink discharged from the nozzles 4 in the nozzle array can be suppressed. More preferably, the resonance period Tcg of the first adjacent portion 8A and the resonance period Tcp of the pressure generation chamber 6 are set so as to satisfy Expression 11, thereby further suppressing the variations in the speed and volume of the ink discharged from the nozzles 4 in the nozzle array.

The ratio of resonance periods Tcg/Tcp is preferably changed by adjusting the length lg or the cross-sectional areas sg of the first adjacent portion 8A so that the value of Tcg/Tcp falls within the above-described range. That is, since other values (such as the length lp of the pressure generation chamber 6) affect the basic performance of the head 100, the values regarding the pressure generation chamber 6 is preferably set to ideal values for obtaining desired basic performance without considering an effect of the resonance period Tcp. In other words, by adjusting the length lg and the cross-sectional areas sg of the first adjacent portion 8A, the ratio of resonance periods Tcg/Tcp can be adjusted without adversely affecting the basic performance of the head 100.

Next, with reference to FIG. 4, a description is given of a result of an experiment for obtaining a relation between the value of Tcg/Tcp and the variation of the speed of the ink discharged from the nozzles 4 in the nozzle array. The vertical axis in FIG. 4 represents the variation (%) of the speed of the ink discharged from the nozzles 4 in the nozzle array. The variation (%) in the nozzle array is calculated by the following Expression 26:

$$The variation in the nozzle array ( \% ) = ( standard deviation of the speed of the ink discharged from the nozzles 4 in the nozzle array ) \text{/} ( average value of the speed of the ink discharged from the nozzles 4 in the nozzle array ) \times 100. \qquad Expression 26$$

The evaluation conditions in the experiment in FIG. 4 are as follows. Ultraviolet (UV) ink having a viscosity of 5 to 15 cP is used. The piezoelectric element 12A is driven at a frequency of 2 to 50 kHz. A pulse voltage is applied to the piezoelectric element 12A so that ink is discharged at a speed of about 6 to 8 m/s.

The speed of the ink was measured as follows. The pulse voltage was applied to the piezoelectric element 12A at a constant drive frequency to periodically discharge the ink from each nozzle 4. The discharged ink was irradiated with strobe light synchronized with the vibration cycle to capture an image of the ink flying in the air. As a result, droplets of the ink, which are stationary in the air in the image, can be observed. In each nozzle 4, the distance between the droplets of the ink in the image is measured, and divided by the vibration cycle, thereby calculating the speed of the ink.

When the ink was periodically discharged from the nozzle 4 as described above, a sheet of gloss paper was placed 1 to 4 mm away from the nozzle plate 1, and moved at a constant speed in a direction (longitudinal direction of the pressure generation chamber 6) perpendicular to the direction in which the pressure generation chambers 6 are arranged. Accordingly, the ink adhered to the sheet of gloss paper to print an image on the sheet.

As illustrated in FIG. 4, the value of Tcg/Tcp not greater than 0.79 (see vertical line Xa₁), or not less than 1.29 (see vertical line Xa₂) can suppress the variation in the speed of the ink in the nozzle array within 2% (see horizontal line L1). Further, the value of Tcg/Tcp not greater than 0.68 (see vertical line Xb₁), or not less than 1.88 (see vertical line Xb₂) can suppress the variation in the speed of the ink in the nozzle array within 1.5% (see horizontal line L2). Thus, the value of Tcg/Tcp in the range indicated by Expression 1 or Expression 11 can suppress the variation in the speed of the ink in the nozzle array.

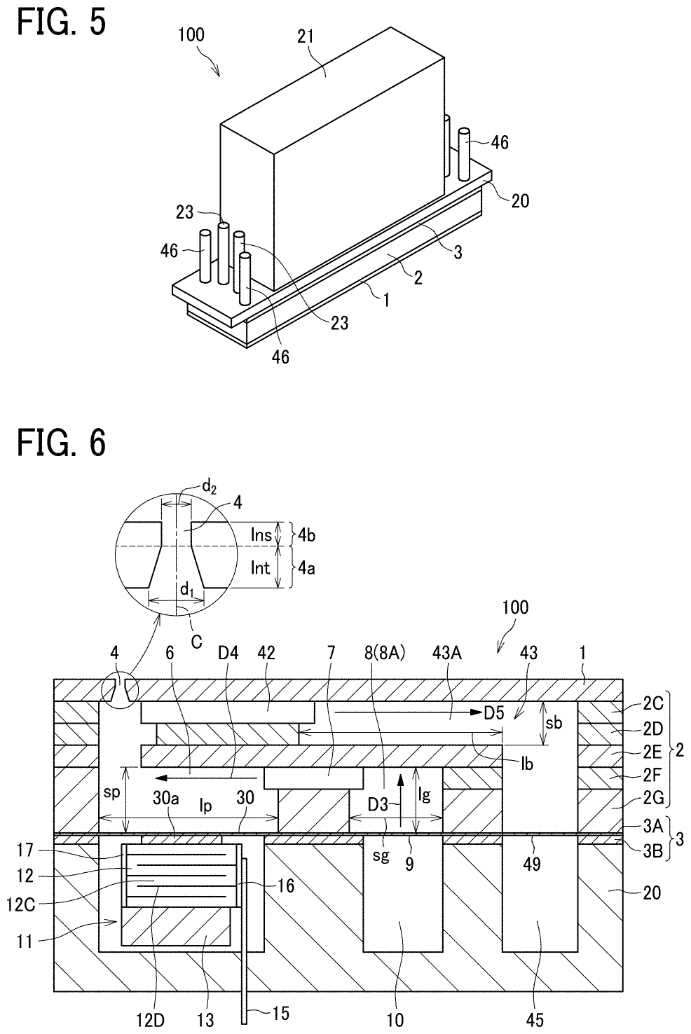

Another example of the head 100 according to the present embodiment is described with reference to FIGS. 5 and 6. FIG. 5 is a perspective view of the head 100 according to the present embodiment. FIG. 6 is a cross-sectional view of the head 100 along a direction (longitudinal direction of the pressure generation chamber 6) perpendicular to the nozzle array direction. Redundant description of elements that are in common with the above-described embodiment is omitted below.

As illustrated in FIGS. 5 and 6, the head 100 includes the nozzle plate 1, the channel plate 2, and the diaphragm 3 as a wall that are laminated one on another and bonded to each other. The head 100 further includes the piezoelectric actuator 11 that displaces the diaphragm 3, the frame 20 as a common liquid chamber substrate, and a cover 21. As illustrated in FIG. 5, the cover 21 is mounted on the frame 20 to cover the frame 20 and the like.

The channel plate 2 defines a collection-side fluid restrictor 42 and a collection channel 43 on the nozzle plate 1 side. The collection channel 43 communicates with a collection-side common liquid chamber 45 via a discharge hole 49. The collection channel 43 communicates with the collection-side fluid restrictor 42. The frame 20 defines the collection-side common liquid chamber 45. As illustrated in FIG. 5, the frame 20 includes a supply port 23 communicating with the common liquid chamber 10 and a collection port (circulation port) 46 communicating with the collection-side common liquid chamber 45. The channel plate 2 includes five plate members 2C, 2D, 2E, 2F, and 2G laminated one on another from the nozzle plate 1 side. However, the number of plate members constructing the channel plate 2 is not limited thereto.

In the present embodiment, the head 100 includes a collection-side path through which the ink circulates, and the resonance period Tcp of the pressure generation chamber 6 is different from the resonance period Tcg of the first adjacent portion 8A. In addition, the resonance period Tcb of a second adjacent portion 43A is different from the resonance period Tcp and the resonance period Tcg. As a result, the variation in the meniscus pressure can be suppressed between the pressure generation chambers 6 when pressure is applied to each pressure generation chamber 6. Therefore, the variations in the speed and volume of the ink discharged from the nozzles 4 can be suppressed in the nozzle array. Thus, the variations in ink landing positions and print density can be suppressed in the nozzle array of the nozzles 4, thereby improving the print quality by liquid discharge of the head 100.

The second adjacent portion 43A is a portion of the collection channel 43. That is, the second adjacent portion 43A communicates with (is adjacent to) the collection-side fluid restrictor 42, and has a substantially uniform shape in a certain range when viewed from the collection-side fluid restrictor 42. More specifically, the second adjacent portion 43A is disposed in the certain range in which the substantially uniform shape continues in cross-section. Here, the cross-section is along a first direction (in particular, the vertical direction in the present embodiment) and continuously taken along a second direction (the left direction in FIG. 6). The first direction intersects the second direction. The second direction is opposite to the direction in which a fluid mainly flows in the portion of the collection channel 43 adjacent to the collection-side fluid restrictor 42 (in the present embodiment, the second direction is opposite to the direction in which the fluid flows in the collection-side fluid restrictor 42). In the present embodiment, a portion having a length lb indicated by arrow in FIG. 6 is the second adjacent portion 43A. However, the uniform shape may not be strictly uniform, and may have some changes in shape such as unevenness. On the right side of the portion having the length lb in FIG. 6, the collection channel 43 extends downward as illustrated in the drawing. The right side portion of the collection channel 43 has a shape different from that of the portion of the collection channel 43 adjacent to the collection-side fluid restrictor 42 (the fluid such as ink also flows in a different direction). That is, the right side portion of the collection channel 43 does not have the uniform shape described above, and is not included in the second adjacent portion 43A.

The entire guide channel 8 has the substantially uniform shape in cross-section. Here, the cross-section is along a first direction (in particular, the horizontal direction in the present embodiment) and continuously taken in a second direction (a downward direction in FIG. 6). The first direction intersects the second direction. The second direction is opposite to the direction in which a fluid mainly flows in the portion of the guide channel 8 adjacent to the fluid restrictor 7. Therefore, the first adjacent portion 8A coincides with the entire guide channel 8 in the present embodiment.

The value of Tcg/Tcp, which is the quotient of the resonance period Tcg of the first adjacent portion 8A divided by the resonance period Tcp of the pressure generation chamber 6, and the value of Tcb/Tcp, which is the quotient of the resonance period Tcb of the second adjacent portion 43A divided by the resonance period Tcp of the pressure generation chamber 6, are set within a predetermined range, thereby further reducing the influence of the pressure wave. The resonance period Tcp of the pressure generation chamber 6, the resonance period Tcg of the first adjacent portion 8A, and the resonance period Tcb of the second adjacent portion 43A are calculated by the following Expressions 13 to 24:

$$\begin{matrix}Tcp = 2 π \times [ √ \{ ( Lp + Ln ) \times Cp \} + √ ( Lp \times Cp ) ] \text{/} 2 ; & Expression 13 \\ Lp = ρ \times ( 1 p \text{/} 2 ) \text{/} sp ; & Expression 14 \\ Ln = Lnt + Lns ; & Expression 15 \\ Lnt = 4 \times ρ \times 1 nt \text{/} ( π \times {d}_{1} \times {d}_{2} ) ; & Expression 16 \\ Lns = 4 \times ρ \times 1 ns \text{/} ( π \times {d}_{2}^{2} ) ; & Expression 17 \\ Cp = ( 1 p \text{/} 2 ) \times sp \text{/} ( ρ \times {c}^{2} ) \times 2.5 ; & Expression 18 \\ Tcg = 2 π \times √ ( Lg \times Cg ) ; & Expression 19 \\ Lg = ρ \times ( 1 g \text{/} 2 ) \text{/} sg ; & Expression 20 \\ Cg = ( 1 g \text{/} 2 ) \times sg \text{/} ( ρ \times {c}^{2} ) . & Expression 21 \\ Lb = ρ \times ( 1 b \text{/} 2 ) \text{/} sb ; and & Expression 23 \\ Cb = ( 1 b \text{/} 2 ) \times sb \text{/} ( ρ \times {c}^{2} ) . & Expression 24\end{matrix}$$

Here:

Tcp (s) represents the resonance period of the pressure generation chamber 6;

Tcg (s) represents the resonance period of the first adjacent portion 8A;

Tcb (s) represents the resonance period of the second adjacent portion 43A;

ρ (kg/m³) represents the density of ink (liquid);

c (m/s) represents the sonic velocity in the ink (liquid);

lp (m) represents the length of the pressure generation chamber 6 in a direction in which the ink (liquid) flows in the pressure generation chamber 6;

sp (m²) represents the cross-sectional area of the pressure generation chamber 6 in a plane perpendicular to the direction in which the ink (liquid) flows in the pressure generation chamber 6;

lnt (m) represents the length of the tapered portion 4a along the center line of the nozzle 4;

lns (m) represents the length of the straight portion 4b along the center line of the nozzle 4;

d₁ (m) represents the first diameter of the nozzle 4;

d₂ (m) represents the second diameter of the nozzle 4;

lg (m) represents the length of the first adjacent portion 8A in a direction in which the ink (liquid) flows in the first adjacent portion 8A;

sg (m²) represents the cross-sectional area of the first adjacent portion 8A in a plane perpendicular to the direction in which the ink (liquid) flows in the first adjacent portion 8A;

lb (m) represents a length of the second adjacent portion 43A in a direction in which the ink (liquid) flows in the second adjacent portion 43A; and

sb (m²) represents a cross-sectional area of the second adjacent portion 43A in a plane perpendicular to the direction in which the ink (liquid) flows in the second adjacent portion 43A.

In FIG. 6, liquid flows in the first adjacent portion 8A in the direction indicated by arrow D3, flows in the pressure generation chamber 6 in the direction indicated by arrow D4, and flows in the second adjacent portion 43A in the direction indicated by arrow D5. Although ink (liquid) flows in three directions (the vertical direction, the horizontal direction, and the direction perpendicular to the surface of the paper on which FIG. 6 is drawn) perpendicular to each other along wall surfaces defining the pressure generation chamber 6, the guide channel 8, or the collection channel 43, the ink (liquid) mainly flows in the first adjacent portion 8A, the second adjacent portion 43A, and the pressure generation chamber 6 in the directions indicated by arrows D3 to D5 (a direction in which a distance of liquid flow is longest). For example, in the guide channel 8, when the ink flows from the opening 9 to the fluid restrictor 7, the direction indicated by arrow D3 in the drawing is the direction in which the ink flows the longest distance.

The lengths lp, lnt, lns, lg, and lb and the diameters d₁, d₂ refer to the respective ranges indicated by arrows in FIG. 6. The cross-sectional area sp is defined by the range (i.e., the length lp) indicated by arrow in FIG. 6 and the width of the pressure generation chamber 6 in the direction perpendicular to the surface of the paper on which FIG. 6 is drawn, the cross-sectional area sg is defined by the range (i.e., the length lg) indicated by arrow in FIG. 6 and the width of the first adjacent portion 8A in the direction perpendicular to the surface of the paper on which FIG. 6 is drawn, and the cross-sectional area sb is defined by the range (i.e., the length lb) indicated by arrow in FIG. 6 and the width of the second adjacent portion 43A in the direction perpendicular to the surface of the paper on which FIG. 6 is drawn. An average value of the length of the pressure generation chamber 6 in the horizontal direction in FIG. 6, which is the longitudinal direction of the pressure generation chamber 6, may be calculated and can be used as the length lp. Similarly, the respective average values can be used as the lengths lg and lb and the cross-sectional areas sp, sg, and sb.

In the present embodiment, the collection channel 43 has the length lb in a range of 500×10⁻⁶ to 5000×10⁻⁶ m, and the cross-sectional areas sb in a range of 3200×10⁻¹² to 15600×10⁻¹² m². Other values are the same as those in the above-described embodiment.

The values of Tcg/Tcp and Tcb/Tcp are set in a range indicated by Expression 12 or Expression 25:

$$\begin{matrix}Tcg \text{/} Tcp \leq 0.79 and Tcb \text{/} Tcp \leq 0.79 , or Tcg \text{/} Tcp \geq 1.29 and Tcb \text{/} Tcp \geq 1.29 ; or & Expression 12 \\ Tcg \text{/} Tcp \leq 0.68 and Tcb \text{/} Tcp \leq 0.68 , or Tcg \text{/} Tcp \geq 1.88 and Tcb \text{/} Tcp \geq 1.88 . & Expression 13\end{matrix}$$

Here, Tcp (s) represents the resonance period of the pressure generation chamber 6, Tcg (s) represents the resonance period of the first adjacent portion 8A, and Tcb (s) represents the resonance period of the second adjacent portion 43A.

Preferably, the resonance periods Tcg, Tcp, and Tcb are set so as to satisfy Expression 12, thereby suppressing the variation in the meniscus pressure between the pressure generation chambers 6 when pressure is applied to each pressure generation chamber 6. With this setting, the variations in the speed and volume of the ink discharged from the nozzles 4 in the nozzle array can be suppressed. More preferably, the resonance periods Tcg, Tcp, and Tcb are set so as to satisfy Expression 25, thereby further suppressing the variations in the speed and volume of the ink discharged from the nozzles 4 in the nozzle array.

In the present embodiment, the ratio of resonance periods Tcg/Tcp is preferably changed by adjusting the length lg or the cross-sectional area sg of the first adjacent portion 8A so that the value of Tcg/Tcp falls within the above-described range, and the ratio of resonance periods Tcb/Tcp is preferably changed by adjusting the length lb or the cross-sectional area sb of the second adjacent portion 43A so that the value of Tcg/Tcp falls within the above-described range. Thus, the ratios of resonance periods Tcg/Tcp and Tcb/Tcp can be adjusted without adversely affecting the basic performance of the head 100.

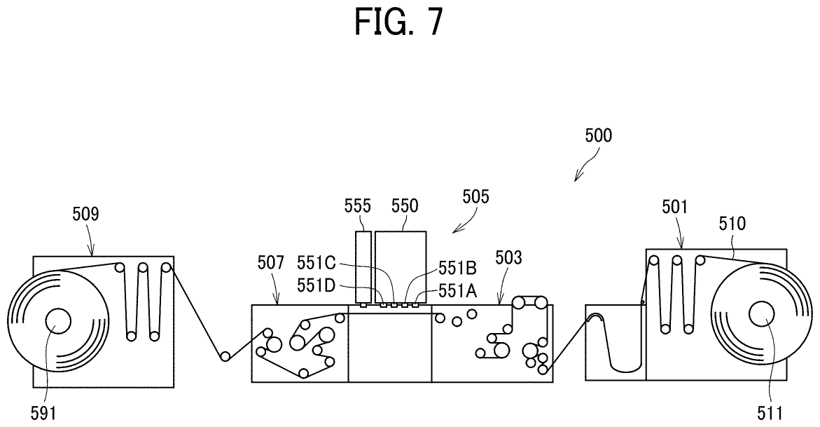

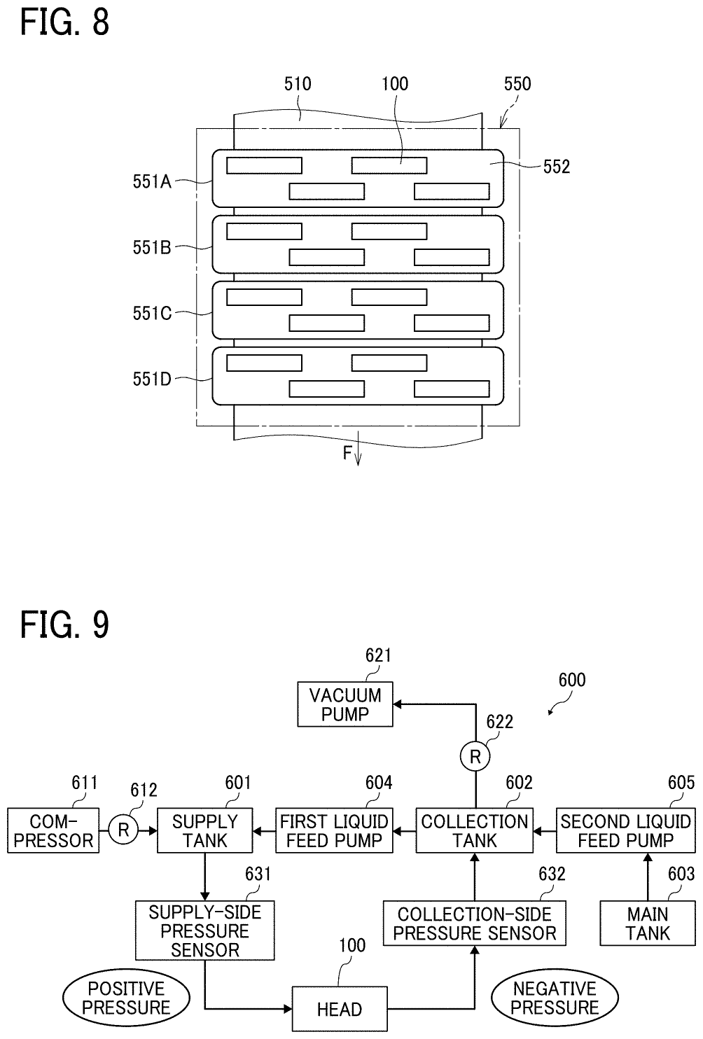

Next, an example of a liquid discharge apparatus according to the present disclosure is described with reference to FIGS. 7 and 8. FIG. 7 is a schematic view of the liquid discharge apparatus. FIG. 7 is a plan view of a head unit of the liquid discharge apparatus in FIG. 8. As illustrated in FIG. 7, a printing apparatus 500 serving as the liquid discharge apparatus includes a feeder 501, a guide conveyor 503, a printing unit 505, a dryer 507, and a carrier 509. The feeder 501 carries in a continuous medium 510. The guide conveyor 503 guides and conveys the continuous medium 510 such as a continuous sheet of paper or a sheet material fed from the feeder 501 to the printing unit 505. The printing unit 505 discharges liquid onto the continuous medium 510 to form (print) an image. The dryer 507 dries the continuous medium 510 on which the image has been formed. The carrier 509 carries out the dried continuous medium 510.

The continuous medium 510 is fed from a winding roller 511 of the feeder 501. Then, the continuous medium 510 is guided and conveyed with rollers of the feeder 501, the guide conveyor 503, the dryer 507, and the carrier 509, and wound around a take-up roller 591 of the carrier 509. In the printing unit 505, the continuous medium 510 is conveyed on a conveyance guide so as to face a head unit 550 and a head unit 555. At this time, the head unit 550 discharges liquid to form an image on the continuous medium 510. Thereafter, the head unit 555 discharges treatment liquid to the continuous medium 510 to perform post-treatment.

Here, the head unit 550 includes, for example, full-line head arrays 551A, 551B, 551C, and 551D for four colors from the upstream side in a conveyance direction of the continuous medium 510 indicated by arrow F in FIG. 8. Hereinafter, the full-line head arrays 551A, 551B, 551C, and 551D are simply referred to as the “head array 551” when colors are not distinguished. Each of the head arrays 551 is a liquid discharger to discharge liquid of black (K), cyan (C), magenta (M), or yellow (Y) onto the continuous medium 510 conveyed along the conveyance direction. Note that the number and types of colors used in the head arrays 551 are not limited to the above-described four colors of K, C, M, and Y and may be any other suitable number and types. In the head array 551, for example, the heads 100 according to above-described embodiments of the present disclosure are arranged in a staggered manner on a base 552 as illustrated in FIG. 8. Note that embodiments of the present disclosure are not limited to such an arrangement and any other suitable head arrangement may be adopted.

FIG. 9 illustrates an example of a liquid circulation device 600 employed in the printing apparatus 500 according to the present embodiment. FIG. 9 is a block diagram of the liquid circulation device 600. Although only one head 100 is illustrated in FIG. 9, in the structure including a plurality of heads 100 as illustrated in FIG. 8, a plurality of supply-side flow paths and a plurality of collection-side flow paths are respectively connected via manifolds or the like to the supply sides and collection sides of the plurality of heads 100.

The liquid circulation device 600 includes a supply tank 601, a collection tank 602, a main tank 603, a first liquid feed pump 604, a second liquid feed pump 605, a compressor 611, a regulator 612, a vacuum pump 621, a regulator 622, a supply-side pressure sensor 631, and a collection-side pressure sensor 632.

The compressor 611 and the vacuum pump 621 together generate a difference of pressure between the pressure in the supply tank 601 and the pressure in the collection tank 602. The supply-side pressure sensor 631 is disposed between the supply tank 601 and the head 100 and coupled to the supply-side flow path connected to the supply port 23 of the head 100. The collection-side pressure sensor 632 is disposed between the head 100 and the collection tank 602 and coupled to the collection flow path connected to the collection port 46 of the head 100. One end of the collection tank 602 is coupled to the supply tank 601 via the first liquid feed pump 604, and another end of the collection tank 602 is coupled to the main tank 603 via the second liquid feed pump 605. Thus, the liquid circulation device 600 forms a circulation path in which the liquid circulates through the head 100. Specifically, the liquid flows from the supply tank 601 into the head 100 via the supply port 23. The liquid is collected through the collection port 46 to the collection tank 602. Further, the first liquid feed pump 604 feeds the liquid collected in the collection tank 602 to the supply tank 601.

The compressor 611 is coupled to the supply tank 601. A controller of the liquid circulation device 600 drives the compressor 611 so that a predetermined positive pressure is detected by the supply-side pressure sensor 631. On the other hand, the vacuum pump 621 is coupled to the collection tank 602. The controller of the liquid circulation device 600 drives the vacuum pump 621 so that a predetermined negative pressure is detected by the collection-side pressure sensor 632. Such a configuration allows the meniscus of liquid to be maintained at a constant negative pressure while circulating the liquid through the head 100.

When the liquid is discharged from the nozzles 4 of the head 100, the amount of liquid in each of the supply tank 601 and the collection tank 602 decreases. Therefore, the second liquid feed pump 605 replenishes liquid from the main tank 603 to the collection tank 602 as appropriate. The timing of liquid replenishment from the main tank 603 to the collection tank 602 can be controlled based on the detection result of a liquid level sensor provided in the collection tank 602. For example, the controller of the liquid circulation device 600 causes the second liquid feed pump 605 to replenish liquid from the main tank 603 to the collection tank 602 when the liquid level of the liquid in the collection tank 602 falls below a predetermined height.

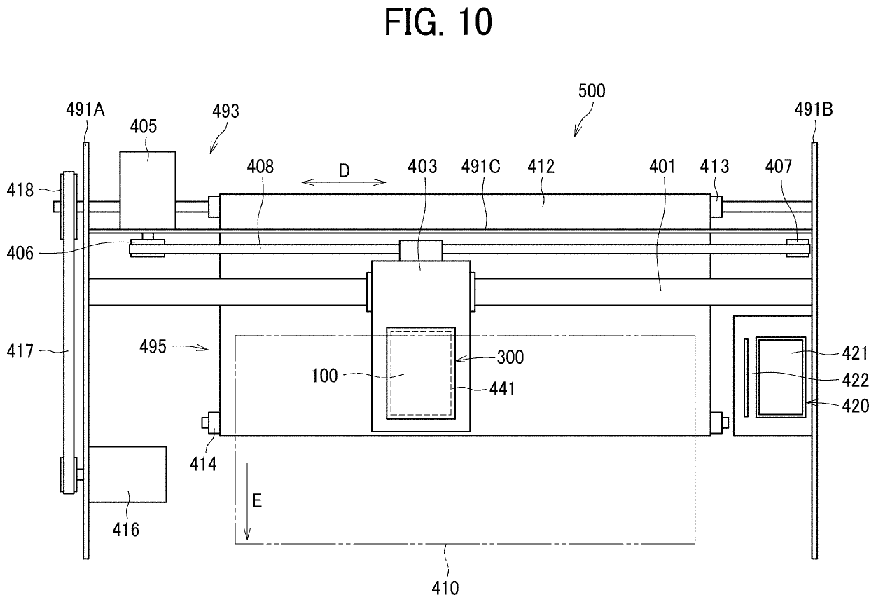

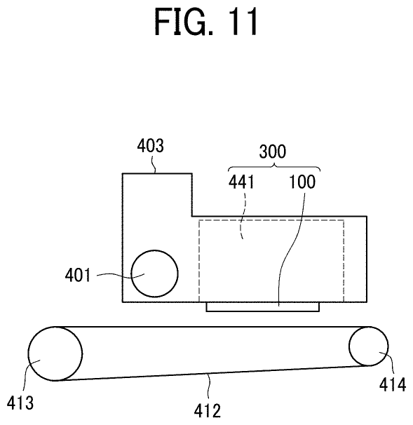

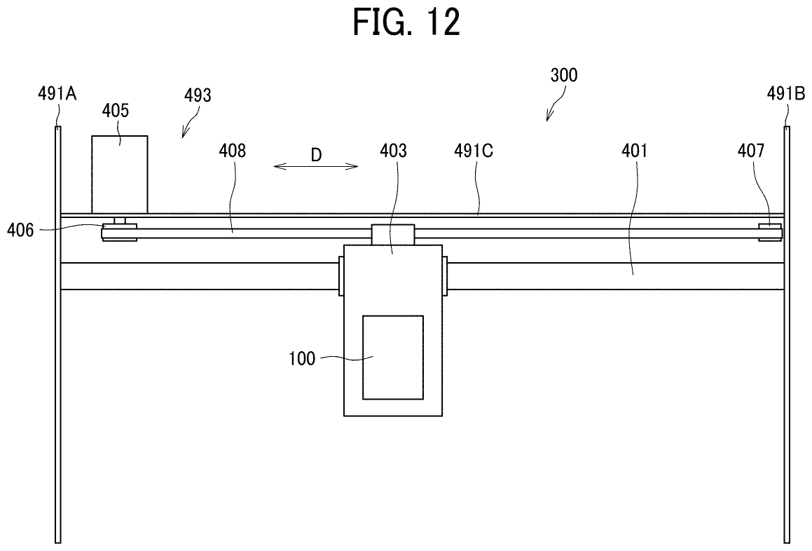

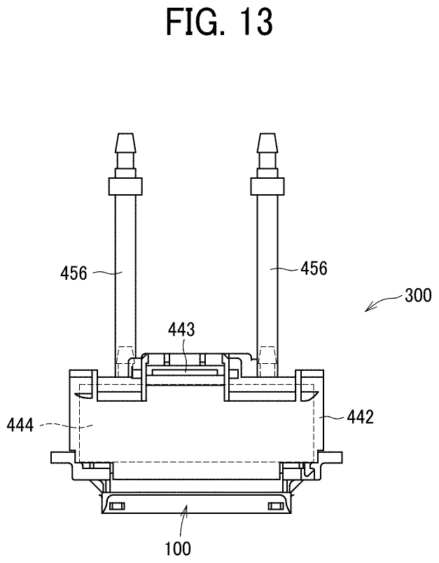

Next, another example of the printing apparatus 500 as the liquid discharge apparatus according to the present disclosure is described with reference to FIGS. 10 and 11. FIG. 10 is a plan view of a part of the printing apparatus 500. FIG. 11 is a side view of the part of the printing apparatus 500 in FIG. 12. The printing apparatus 500 is a serial type apparatus, and a main-scanning moving mechanism 493 reciprocally moves a carriage 403 in the main scanning direction D. The main-scanning moving mechanism 493 includes, e.g., a guide 401, a main-scanning motor 405, and a timing belt 408. The guide 401 is bridged between left and right side plates 491A and 491B to moveably hold the carriage 403. The main-scanning motor 405 reciprocally moves the carriage 403 in the main scanning direction D via the timing belt 408 looped around a drive pulley 406 and a driven pulley 407.

The carriage 403 mounts a liquid discharge device 300 including the head 100 according to the above-described embodiments and a head tank 441 as a single integrated unit. The head tank 441 stores liquid to be supplied to the head 100. The head 100 of the liquid discharge device 300 discharges color liquid of, for example, yellow (Y), cyan (C), magenta (M), or black (K). In the head 100, a plurality of nozzles 4 is arranged in the sub-scanning direction E perpendicular to the main scanning direction D to form the nozzle array. An opening of each nozzle 4 faces downward, and the head 100 discharges liquid downward from each nozzle 4 (i.e., a liquid discharge direction of the nozzle 4). The head 100 is coupled to the liquid circulation device 600 described above, and the liquid circulation device 600 supplies and circulates liquid of a required color.

The printing apparatus 500 includes a conveyance mechanism 495 to convey a sheet 410. The conveyance mechanism 495 includes a conveyance belt 412 as a conveyor and a sub-scanning motor 416. The sub-scanning motor 416 drives the conveyance belt 412. The conveyance belt 412 attracts the sheet 410 and conveys the sheet 410 at a position facing the head 100. The conveyance belt 412 is an endless belt stretched between a conveyance roller 413 and a tension roller 414. The sheet 410 can be attracted to the conveyance belt 412 by electrostatic attraction, air suction, or the like. The sub-scanning motor 416 rotates the conveyance roller 413 via the timing belt 417 and the timing pulley 418. As a result, the conveyance belt 412 rotates, and the surface of the conveyance belt 412 to which the sheet 410 is attracted moves in the sub-scanning direction E.

At one side in the main scanning direction D of the carriage 403, a maintenance mechanism 420 is disposed on a lateral side (right side in FIG. 10) of the conveyance belt 412. The maintenance mechanism 420 recovers the head 100 and maintains the head 100 in good condition. The maintenance mechanism 420 includes, for example, a cap 421 and a wiper 422. The cap 421 caps a nozzle face (a surface on which nozzles are formed) of the head 100. The wiper 422 wipes the nozzle face. The main-scanning moving mechanism 493, the maintenance mechanism 420, and the conveyance mechanism 495 are mounted onto a housing including the side plates 491A and 491B and a back plate 491C.

In the printing apparatus 500 having the above-described configuration, the sheet 410 is fed and attracted onto the conveyance belt 412 and conveyed in the sub-scanning direction E by the circumferential movement of the conveyance belt 412. The head 100 is driven in response to image signals while the carriage 403 moves in the main scanning direction D. Thus, the head 100 discharges liquid onto the sheet 410 not in motion, thereby forming an image.

Next, another example of the liquid discharge device 300 according to the present disclosure is described with reference to FIG. 12. FIG. 12 is a plan view illustrating a part of the liquid discharge device 300. The liquid discharge device 300 includes a housing, the main-scanning moving mechanism 493, the carriage 403, and the head 100. The housing includes side plates 491A and 491B, and the back plate 491C. These are some of the components constructing the liquid discharge apparatus. Note that, the liquid discharge device 300 may further includes the maintenance mechanism 420 described above. In this case, the maintenance mechanism 420 is attached to the side plate 491B, for example.

Next, still another example of the liquid discharge device 300 according to the present disclosure is described with reference to FIG. 13. FIG. 13 is a front view of the liquid discharge device 300. The liquid discharge device 300 includes the head 100 to which a channel component 444 is attached, and a tube 456 connected to the channel component 444 to supply liquid to the head 100. The channel component 444 is disposed inside a cover 442. In some embodiments, the liquid discharge device 300 may include the head tank 441 (see FIG. 11) instead of the channel component 444. A connector 443 for electrically connecting to the head 100 is provided on an upper portion of the channel component 444.

The configuration according to the present disclosure can also be applied to the head 100 provided in the liquid discharge device or the liquid discharge apparatus in the above-described examples. Thus, the variations in the speed and volume of the ink can be suppressed to suppress the variations in ink landing positions and print density in the nozzle array of the nozzles 4, thereby improving the print quality by liquid discharge of the head 100.

In the present disclosure, “liquid” discharged from a head is not limited to any particular type as long as the liquid has a viscosity and surface tension of degrees dischargeable from the head. However, preferably, the viscosity of the liquid discharged from the head is not greater than 30 mPa·s under ordinary temperature and ordinary pressure or by heating or cooling. Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. These liquids can be used for, e.g., inkjet ink, surface treatment solution, a liquid for forming components of electronic element or light-emitting element or a resist pattern of electronic circuit, or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric conversion element, such as a thermal resistor, and an electrostatic actuator including a diaphragm and a counter electrode.

The “liquid discharge device” is an assembly of parts relating to liquid discharge. The term “liquid discharge device” represents a structure including the liquid discharge head and a functional part(s) or unit(s) combined with the liquid discharge head as a single unit. For example, the “liquid discharge device” includes a combination of the liquid discharge head with at least one of a head tank, a carriage, a supply mechanism, a maintenance mechanism, or a main-scanning moving mechanism.

Here, the integrated unit may be, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or unit(s) s each other.

For example, the liquid discharge head and the head tank are integrated as the liquid discharge device. Alternatively, the liquid discharge head and the head tank coupled (connected) to each other via a tube or the like may form the liquid discharge device as a single unit. Here, a unit including a filter may further be added to a portion between the head tank and the liquid discharge head.

In another example, the liquid discharge device may be an integrated unit in which a liquid discharge head is integrated with a carriage.

As yet another example, the liquid discharge device is a unit in which the liquid discharge head and the main-scanning moving mechanism are combined into a single unit. The liquid discharge head is movably held by a guide that is a part of the main-scanning moving mechanism. The liquid discharge device may include the liquid discharge head, the carriage, and the main-scanning moving mechanism that are integrated as a single unit.

In another example, the cap that forms part of the maintenance mechanism is secured to the carriage mounting the liquid discharge head so that the liquid discharge head, the carriage, and the maintenance unit are integrated as a single unit to form the liquid discharge device.

Further, in still another example, the liquid discharge device includes a tube connected to the head tank or the liquid discharge head mounting the channel component so that the liquid discharge head and the supply mechanism are integrated as a single unit.

The main-scanning moving mechanism may be a guide only. The supply mechanism may be a tube(s) only or a loading device only.

In the above-described embodiments, the “liquid discharge apparatus” includes the liquid discharge head or the liquid discharge device and drives the liquid discharge head to discharge liquid. The liquid discharge apparatus may be, for example, an apparatus capable of discharging liquid to a material onto which liquid can adhere or an apparatus to discharge liquid toward gas or into liquid.

The “liquid discharge apparatus” may include devices relating to feeding, conveyance, and ejection of the material to which the liquid can adhere and also include a pre-treatment device and a post-processing device.

The “liquid discharge apparatus” may be, for example, an image forming apparatus or a three-dimensional fabrication apparatus. The image forming apparatus forms an image on a sheet by discharging ink. The three-dimensional fabrication apparatus discharges fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms meaningless images such as meaningless patterns or an apparatus that fabricates three-dimensional images.

The above-described term “material to which liquid can adhere” denotes, for example, a material to which liquid can adhere at least temporarily, a material to which liquid can attach and firmly adhere, or a material to which liquid can adhere and into which the liquid permeates. Specific examples of the “material to which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “material to which liquid is adhere” includes any material to which liquid can adhere, unless particularly limited.

Examples of the “material to which liquid can adhere” include any materials to which liquid can adhere even temporarily, such as paper, thread, fiber, fabric, leather, metal, plastic, glass, wood, and ceramic.

The term “liquid discharge apparatus” may be an apparatus to relatively move the liquid discharge head and the material to which liquid can adhere. However, the liquid discharge apparatus is not limited to such an apparatus. Examples of the liquid discharge apparatus include a serial type apparatus which moves the liquid discharge head, and a line type apparatus which does not move the liquid discharge head.

Examples of the liquid discharge apparatus further include a treatment liquid application apparatus and an injection granulation apparatus. The treatment liquid application apparatus discharges treatment liquid onto a paper sheet to apply the treatment liquid to the surface of the paper sheet, for reforming the surface of the paper sheet. The injection granulation apparatus injects composition liquid, in which a raw material is dispersed in a solution, through a nozzle to granulate fine particle of the raw material.

The terms “image formation,” “recording,” “printing,” “image printing,” and “fabricating” used in the present embodiments may be used synonymously with each other.

As described above, according to the present disclosure, the liquid discharge head can suppress variations in the speed and volume of the liquid discharged from the nozzle.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

What is claimed is:

1. A liquid discharge head comprising:
a nozzle configured to discharge a liquid;
a pressure generation chamber facing the nozzle, the pressure generation chamber having a resonance period Tcp;
a common liquid chamber configured to supply the liquid to the pressure generation chamber;
a fluid restrictor communicating with the pressure generation chamber; and
a guide channel communicating with the fluid restrictor and the common liquid chamber and including a first adjacent portion communicating with the fluid restrictor, the first adjacent portion having a resonance period Tcg different from the resonance period Tcp.

2. The liquid discharge head according to claim 1,
wherein the nozzle includes at least one of a straight portion or a tapered portion, and
wherein the following Expression 1 is satisfied:
$$Tcg \text{/} Tcp \leq 0.79 or Tcg \text{/} Tcp \geq 1.29 , \qquad Expression 1$$
where Tcp (s) represents the resonance period of the pressure generation chamber, Tcg (s) represents the resonance period of the first adjacent portion, and Tcp and Tcg are obtained by the following Expressions 2 to 10:
$$\begin{matrix}Tcp = 2 π \times [ √ \{ ( Lp + Ln ) \times Cp \} + √ ( Lp \times Cp ) ] \text{/} 2 ; & Expression 2 \\ Lp = ρ \times ( 1 p \text{/} 2 ) \text{/} sp ; & Expression 3 \\ Ln = Lnt + Lns ; & Expression 4 \\ Lnt = 4 \times ρ \times 1 nt \text{/} ( π \times {d}_{1} \times {d}_{2} ) ; & Expression 5 \\ Lns = 4 \times ρ \times 1 ns \text{/} ( π \times {d}_{2}^{2} ) ; & Expression 6 \\ Cp = ( 1 p \text{/} 2 ) \times sp \text{/} ( ρ \times {c}^{2} ) \times 2.5 ; & Expression 7 \\ Tcg = 2 π \times √ ( Lg \times Cg ) ; & Expression 8 \\ Lg = ρ \times ( 1 g \text{/} 2 ) \text{/} sg ; and & Expression 9 \\ Cg = ( 1 g \text{/} 2 ) \times sg \text{/} ( ρ \times {c}^{2} ) , & Expression 10\end{matrix}$$
where:
ρ (kg/m³) represents a density of the liquid;
c (m/s) represents a sonic velocity in the liquid;
lp (m) represent a length of the pressure generation chamber in a direction in which the liquid flows in the pressure generation chamber;
sp (m²) represents a cross-sectional area of the pressure generation chamber in a plane perpendicular to the direction in which the liquid flows in the pressure generation chamber;
lnt (m) represents a length of the tapered portion along a center line of the nozzle;
lns (m) represents a length of the straight portion along the center line of the nozzle;
d₁ (m) represents a first diameter of the nozzle;
d₂ (m) represents a second diameter of the nozzle;
lg (m) represents a length of the first adjacent portion in a direction in which the liquid flows in the first adjacent portion; and
sg (m²) represents a cross-sectional area of the first adjacent portion in a plane perpendicular to the direction in which the liquid flows in the first adjacent portion.

3. The liquid discharge head according to claim 2,
wherein the following Expression 11 is satisfied:
$$Tcg \text{/} Tcp \leq 0.68 or Tcg \text{/} Tcp \geq 1.88 . \qquad Expression 11$$

4. A liquid discharge head comprising:
a nozzle configured to discharge a liquid;
a pressure generation chamber facing the nozzle, the pressure generation chamber having a resonance period Tcp;
a common liquid chamber configured to supply the liquid to the pressure generation chamber;
a fluid restrictor communicating with the pressure generation chamber;
a guide channel communicating with the fluid restrictor and the common liquid chamber and including a first adjacent portion communicating with the fluid restrictor, the first adjacent portion having a resonance period Tcg different from the resonance period Tcp,
a collection-side common liquid chamber configured to collect the liquid from the pressure generation chamber;
a collection-side fluid restrictor communicating with the pressure generation chamber; and
a collection channel communicating with the collection-side fluid restrictor and the collection-side common liquid chamber and including a second adjacent portion communicating with the collection-side fluid restrictor, the second adjacent portion having a resonance period Tcb different from the resonance period Tcp and the resonance period Tcg.

5. The liquid discharge head according to claim 4,
wherein the nozzle includes at least one of a straight portion or a tapered portion, and
wherein the following Expression 12 is satisfied:
$$Tcg \text{/} Tcp \leq 0.79 and Tcb \text{/} Tcp \leq 0.79 , or Tcg \text{/} Tcp \geq 1.29 and Tcb \text{/} Tcp \geq 1.29 , \qquad Expression 12$$
where Tcp (s) represents the resonance period of the pressure generation chamber, Tcg (s) represents the resonance period of the first adjacent portion, Tcb (s) represents the resonance period of the second adjacent portion, and Tcp, Tcg, and Tcb are obtained by the following Expressions 13 to 24:
$$\begin{matrix}Tcp = 2 π \times [ √ \{ ( Lp + Ln ) \times Cp \} + √ ( Lp \times Cp ) ] \text{/} 2 ; & Expression 13 \\ Lp = ρ \times ( 1 p \text{/} 2 ) \text{/} sp ; & Expression 14 \\ Ln = Lnt + Lns ; & Expression 15 \\ Lnt = 4 \times ρ \times 1 nt \text{/} ( π \times {d}_{1} \times {d}_{2} ) ; & Expression 16 \\ Lns = 4 \times ρ \times 1 ns \text{/} ( π \times {d}_{2}^{2} ) ; & Expression 17 \\ Cp = ( 1 p \text{/} 2 ) \times sp \text{/} ( ρ \times {c}^{2} ) \times 2.5 ; & Expression 18 \\ Tcg = 2 π \times √ ( Lg \times Cg ) ; & Expression 19 \\ Lg = ρ \times ( 1 g \text{/} 2 ) \text{/} sg ; & Expression 20 \\ Cg = ( 1 g \text{/} 2 ) \times sg \text{/} ( ρ \times {c}^{2} ) . & Expression 21 \\ Lb = ρ \times ( 1 b \text{/} 2 ) \text{/} sb ; \\ and & Expression 23 \\ Cb = ( 1 b \text{/} 2 ) \times sb \text{/} ( ρ \times {c}^{2} ) , & Expression 24\end{matrix}$$
where:
ρ (kg/m³) represents a density of the liquid;
c (m/s) represents a sonic velocity in the liquid;
lp (m) represent a length of the pressure generation chamber in a direction in which the liquid flows in the pressure generation chamber;
sp (m²) represents a cross-sectional area of the pressure generation chamber in a plane perpendicular to the direction in which the liquid flows in the pressure generation chamber;
lnt (m) represents a length of the tapered portion along a center line of the nozzle;
lns (m) represents a length of the straight portion along the center line of the nozzle;
d₁ (m) represents a first diameter of the nozzle;
d₂ (m) represents a second diameter of the nozzle;
lg (m) represents a length of the first adjacent portion in a direction in which the liquid flows in the first adjacent portion;
sg (m²) represents a cross-sectional area of the first adjacent portion in a plane perpendicular to the direction in which the liquid flows in the first adjacent portion;
lb (m) represents a length of the second adjacent portion in a direction in which the liquid flows in the second adjacent portion; and
sg (m²) represents a cross-sectional area of the second adjacent portion in a plane perpendicular to the direction in which the liquid flows in the second adjacent portion.

6. The liquid discharge head according to claim 5,
wherein the following Expression 25 is satisfied:
$$Tcg \text{/} Tcp \leq 0.68 and Tcb \text{/} Tcp \leq 0.68 , or Tcg \text{/} Tcp \geq 1.88 and Tcb \text{/} Tcp \geq 1.88 . \qquad Expression 25$$

7. A liquid discharge device comprising:
the liquid discharge head according to claim 1; and
at least one of a head tank configured to store a liquid to be supplied to the liquid discharge head, a carriage configured to mount the liquid discharge head, a supply mechanism configured to supply the liquid to the liquid discharge head, a maintenance mechanism configured to maintain and recover the liquid discharge head, or a main-scanning moving mechanism configured to move the liquid discharge head in a main scanning direction,
wherein the at least one thereof is integrated with the liquid discharge head as a single unit.

8. A liquid discharge apparatus comprising the liquid discharge head according to claim 1.
